(19) United States
(12) Patent Application Publication
(10) Pub. No.: US 2024/0029934 A1
(43) Pub. Date: Jan. 25, 2024

(54) INDUCTIVE COMPONENT

(71) Applicant: ZF Friedrichshafen AG, Friedrichshafen (DE)

(72) Inventors: Ivonne Trenz, Friedrichshafen (DE); Pengshuai Wang, Eriskirch (DE)

(73) Assignee: ZF Friedrichshafen AG, Friedrichshafen (DE)

(21) Appl. No.: 18/355,261

(22) Filed: Jul. 19, 2023

(30) Foreign Application Priority Data
Jul. 21, 2022 (DE) 102022207458.0

(51) Int. Cl. H01F 27/02; H01F 27/08; H01F 27/24

(52) U.S. Cl. CPC H01F 27/02; H01F 27/085; H01F 27/24

(57) ABSTRACT

An inductor includes a winding that has a predefined inductance, a soft magnetic winding core, and a housing that has a cooling surface for discharging heat from the inductor. This housing encases the winding.

### CROSS-REFERENCE TO RELATED APPLICATION

This application claims priority to German Application No. DE 10 2022 207 458.0, filed on Jul. 21, 2022, the entirety of which is hereby fully incorporated by reference herein.

### FIELD

The present invention relates to an inductor. In particular, the invention relates to a passive inductive power element.

### BACKGROUND AND SUMMARY

An inductor is configured to represent a predefined electric inductance in an electric circuit. The element can be used, for example, for short-term temporary storage of electricity, adjustment of a complex resistor, or damping interferences.

If the inductor is used in a power circuit with larger currents, an inductor can emit so much heat that it must be discharged. A housing for the element can be thermally connected by a thermally conductive element to a cooling element such as a heat sink or cooling channel in an active cooling system for this.

The housing can comprise a material, such as aluminum, that is an efficient thermal conductor. A winding with a predetermined inductance can be held in place by a potting compound in the housing, and electrically insulated from the housing. A predefined spacing between the winding and the housing must be maintained for this during the potting process. The potentially complicated potting process preferably takes place in a vacuum. The bonding or curing of the potting compound may be time-consuming. The overall process can therefore be expensive.

An object of the invention is to create a better inductor and a better method for producing such a component. The invention solves these problems with the subject matter of the present disclosure. Preferred embodiments are also described in the present disclosure.

According to a first aspect of the present invention, an inductor comprises a winding with a predefined inductance, a soft magnetic winding core, and a housing that has a cooling surface for discharging heat from the inductor. The housing is formed with an injection molding process.

The housing can be made of a material that can be used in a casting or injection molding process. An outer shell in the form of a cup such as is used in the prior art is unnecessary. The housing material can cure in a mold and then be removed along with the winding. Maintaining a predefined wall thickness of the housing can be simplified. The housing material that is used can have a lower thermal resistance than a typical potting compound. The inductor can be produced more quickly and less expensively.

A preferred embodiment of the housing comprises a thermosetting polymer. The thermosetting polymer, often referred to as a thermoset, comprises a plastic that can no longer be reshaped after it has cured through heating or other measures. The thermoset contains hard, amorphous, insoluble polymers that can be cross-linked to form a dense network through covalent bonding. Prior to the cross-linking, the thermoset can be a synthetic resin that can be processed as a liquid or paste-like compound. In particular, thermoset can be applied to the winding through an injection molding process.

One embodiment of the winding core is in the form of a ring. The inductor can form a toroidal coil, also referred to as a ring coil, donut coil, or toroidal core coil. A magnetic flux near the winding can be concentrated in the winding core, resulting in smaller leakages. The winding core can be made of a ferromagnetic material such as ferrite or a powdered material.

In a first variation, the winding core is in the housing. The winding can first be placed on the winding core in a desired manner, e.g. in that an electrically conductive wire or band is wound onto the winding core. The winding and the winding core can be coated as a unit, such that they are both encased in the housing. This structure has the advantage of being compact, and secures the winding to the winding core more effectively. Thermal discharge from the winding can take place through the housing. Numerous windings with dedicated winding cores can be encased in a single housing.

In a second variation, the winding core is outside the housing. In this case, the core is first fit onto the winding after the winding has been encased in the housing. This structure may be advantageous if the winding core is to substantially or entirely encompass the winding. The winding core can be open where the cooling surface is located, such that heat from the winding can be drained off more directly, and does not have to pass through the material of the winding core.

In this variation, a winding core can act on numerous windings encased in individual housings. The outer winding core can mechanically reinforce the housing and simplify assembly.

The winding core can comprise two parts, elements, or segments. Some parts can be placed on the winding, while other parts can be placed on one another. There are preferably two parts lying opposite one another in relation to the winding. If the winding encircles a rod-shaped core, the parts can be opposite one in relation to an axis of the rod-shaped core. If the winding encircles a ring-shaped core, the parts can be on opposite sides of an axis passing through the ring. The parts can form two half-shells or one half-shell and one lid.

The inductor also preferably comprises a choke. This generally only has one winding on the winding core and can be used in a variety of ways. In particular, the choke can be used to suppress electrical interference or to improve the magnetic tolerance in a circuit.

The component is also preferably intended for use in an electric drive train. By way of example, the component can be used as a passive power component in an electric link between an electric power storage unit and an electric drive motor. The component can also preferably be used on an electrical power converter. The component is particularly preferably designed for use in a motor vehicle.

Another aspect of the present invention relates to a first method for producing an inductor, comprising steps for the provision of a soft magnetic winding core, placing the winding on the winding core, and encasing the winding core and winding to form a housing.

A first variation of an inductor described herein can be obtained with the first method.

Another aspect of the present invention relates to a second method for producing an inductor, comprising steps for the provision of a winding, encasing the winding to form a housing, and placing a soft magnetic winding core on the housing.

A second variation of an inductor described herein can be obtained with the second method.

Both methods can be used to obtain an inexpensive means for producing inductors. The methods can be used with an injection molding machine for mass production of the component.

The invention shall be explained in greater detail below in reference to the drawings.

### BRIEF DESCRIPTION OF THE DRAWINGS

FIGS. 1, 2, and 3 show a first variation of an inductor;

FIG. 4 shows a second variation of an inductor;

FIG. 5 shows a flow chart for a method;

FIGS. 6 and 7 show sectional views of a second variation of an inductor;

FIGS. 8, 9, and 10 show the second variation of an inductor with winding encased in a housing from various perspectives; and

FIGS. 11, 12, and 13 show numerous windings with individual housings in an external winding core from various perspectives.

### DETAILED DESCRIPTION

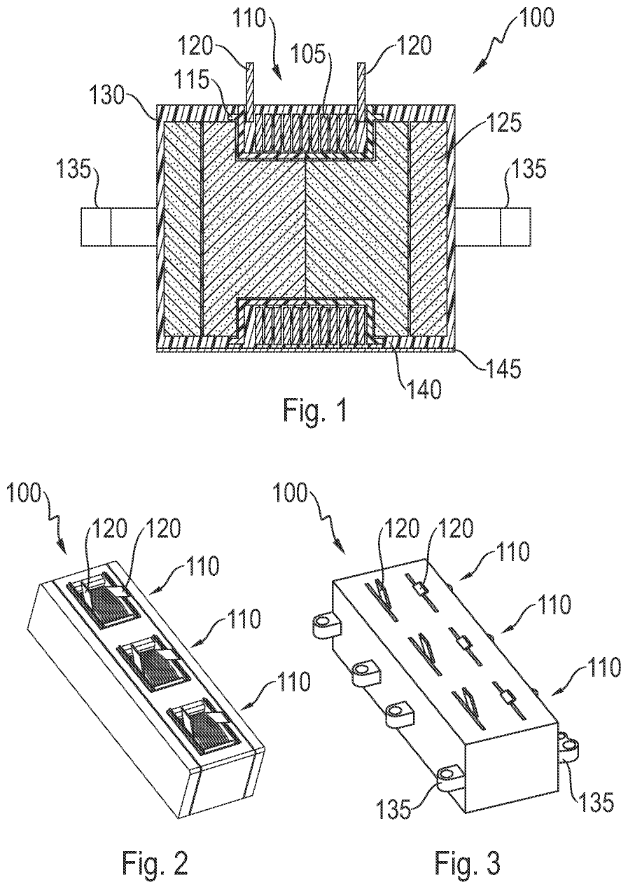

FIG. 1 shows a first variation of an inductor 100. This inductor 100 forms a choke that is preferably designed for use as a passive power component in a switching circuit. The switching circuit can comprise a power converter or control unit for a motor. In one embodiment, the switching circuit is part of a drive train. The switching circuit can be used in a motor vehicle, e.g. a motorcycle, passenger automobile, truck, or bus.

The component 100 comprises an electrical conductor 105 that forms a winding 110. This conductor 105 can be wound onto a non-magnetic support element 115. The windings of the conductor 105 can form a single layer, as shown in the drawing, or they can form numerous layers. In this embodiment, the electrical conductor 105 is formed by a flat band. It can also have a round cross section. The ends of the conductor 105 can form terminals 120 on the winding 110.

The windings of the conductor 105 preferably encircle a winding core 125 composed of a single part or multiple parts. The winding core 125 can be made of ferrite or a powdered material. The winding core 125 can also be on the outside of the winding 110.

The winding 110 and the winding core 125 are encased in a housing that is preferably formed on the winding 110 and the winding core 125 in an injection molding process. The housing 130 encases the winding 110 and winding core 125, as well as the optional support element 115, but leaves the terminals 120 exposed. A fastener 135 can be formed on the housing 130 in order to be able to mechanically secure the inductor 100.

A cooling surface 140 is also formed on the housing 130, at which heat from the inductor is discharged to an element bearing thereon. The housing 130 is preferably made of a thermally conductive material for this. This element can comprise a heat sink for a cooling channel for a coolant. The cooling surface 140 can be thermally bonded to the cooling element by a thermally conductive element 145. The thermally conductive element 145 can comprise a thermally conductive pad, thermally conductive paste, or thermally conductive adhesive. The heat generated in the winding 110 is then discharged through the thermally conductive housing 130 and the thermally conductive element 145.

FIG. 2 shows numerous integrated inductors 100 of the type shown in FIG. 1. There are three windings 110 on a single, multi-part winding core 125 shown therein. To encase the assembly in FIG. 2 in a housing 130, it can be placed in a mold and coated with the housing 130. This coating is preferably a plastic, in particular a thermoset, that can no longer be reshaped after it has cured. The plastic can preferably be a thermally conductive plastic.

FIG. 3 shows the assembly in FIG. 2 encased in the housing 130. The terminals 120 on the windings 110 extend out of the top of the housing 130, and there are fasteners 135 on the side.

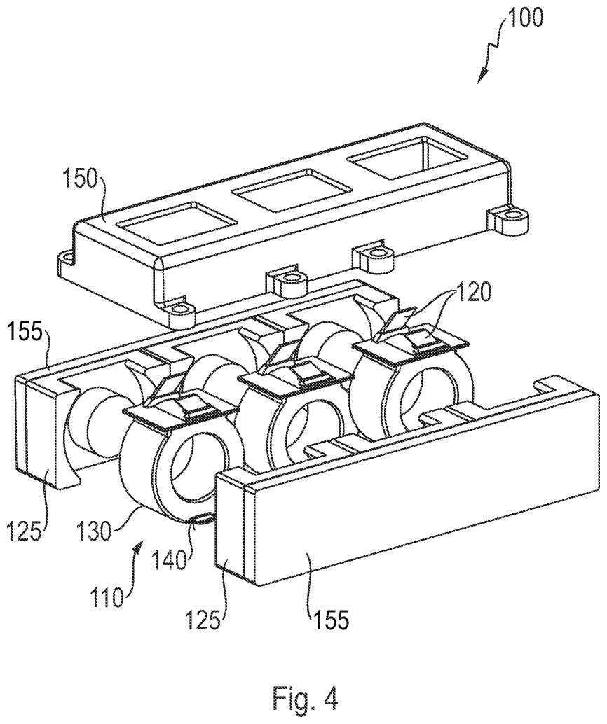

FIG. 4 shows a second variation of an inductor 100. This also has numerous windings 110 and a single, multi-part winding core 125. In this variation, the housing 130 encases each winding 110 separately, and the winding core 125 is outside the housing 130.

Like the embodiments shown in FIGS. 1 to 3, the windings 110 are cylindrical, wherein the elements forming the winding core 125 can be placed thereon from opposing axial directions in relation to the axes of the cylinders. The winding core 125 is preferably shaped such that it substantially fills the inside of a winding 110 and encases the outside thereof. The terminals 120 for the windings 110 can extend out of the housing 130. The elements of the winding core 125 can be glued to one another or the housing 130 with an adhesive.

This embodiment has a bracket 150 that holds the inductor 100 together and/or can be attached to an external object. The bracket 150 in this embodiment has holes through which the terminals 120 on the windings 110 can pass. A cooling surface 140 on the housings 130 encasing each winding 110 is preferably on the surface opposite the terminals 120.

One or more fasteners 135 can be formed on the bracket 150, which can be used to press a cooling surface 140 on the housing 130 against another element. It can be seen herein that a section of the housing 130 that has the cooling surface 140 extends out of the winding core 125, and that the cooling surface 140 is not flat, but instead follows the rounded form of the housing 130.

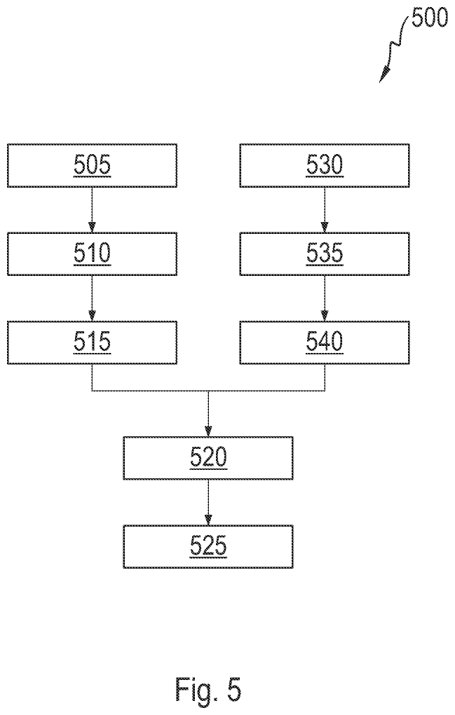

FIG. 5 shows a flow chart for a method 500 for producing an inductor 100. The method 500 has first and second variations, with which either the first or second variation of an inductor 100 described herein can be produced.

In the first variation, the method 500 begins with step 505, in which a winding core 125 is provided. The winding core 125 can be composed of a single piece or two pieces. In step 510, a winding 110 is placed on the winding core 125. The winding 110 is preferably wound separately in advance, and then placed on the respective winding core 125. The winding core 125, preferably comprising two parts, is then glued together. In this case, this means that the parts thereof are glued together. A plate 155, made of ferrite in particular, can then be glued to numerous winding cores 125.

In step 515, the winding core 125 or the winding 110, as well as the support structure 115, can then be coated to form the housing 130. The assembly composed of the winding core 125 and the winding can then be placed in a mold and secured in place. Spacings between the assembly and the mold can be predefined in all directions for this. A liquid or paste-like compound can then be injected into the spaces, such that the compound encases the assembly. After hardening or curing, the compound forms the housing 130.

The housing 130 has a cooling surface 140 that can bear on a cooling element. In step 520, a thermally conductive element 145 can be attached to the cooling surface 140. The housing 130 can then be attached to a cooling element in step 525.

In the second variation, the method 500 starts with step 530, in which a winding 110 is provided, which can be self-supporting or on a support element 115. In step 535, the winding 110 can be encased in a housing 130. The winding 110 can be placed in a mold for this, and encased in a liquid or paste-like compound. Once the compound has cured sufficiently, the mold can be opened and the winding 110 encased in the housing 130 can be removed. An external winding core 125 can then be placed on the housing 130 in step 540. This winding core 125 can also be a single piece, or it can be composed of multiple parts. The method can then continue with the steps 520 and 525 described in the first variation.

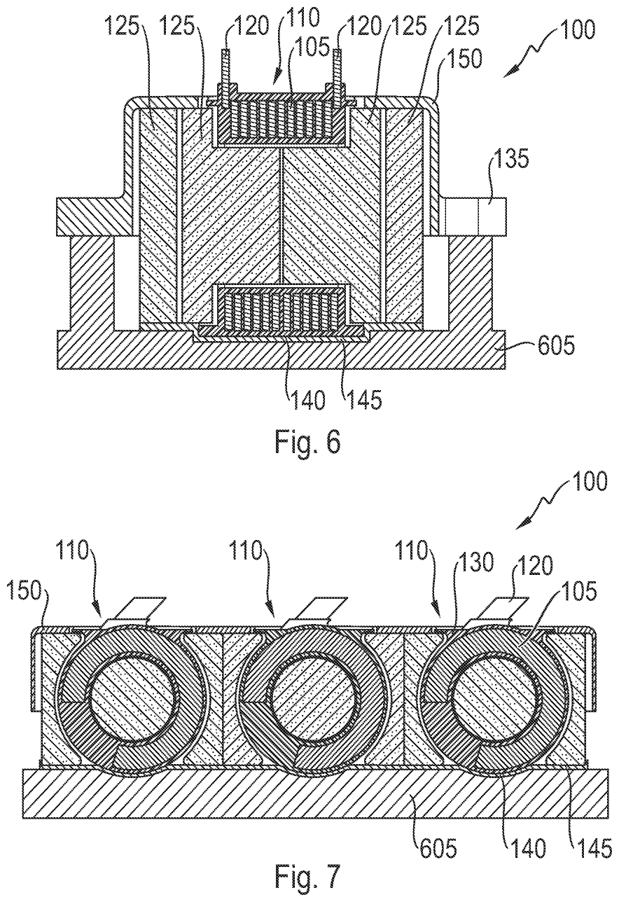

FIGS. 6 and 7 show sectional views of a second variation of an inductor 100. FIG. 6 shows the winding 110 cut along the longitudinal axis thereof, and FIG. 7 show a lateral cut. The winding core 125 is made of four parts in this embodiment (see FIG. 4). A thermally conductive element 145 that bears on a cooling element 605 is attached to the cooling surface 140. The inductor 100 can be mechanically attached to a cooling element 605 with the fasteners 135 on the bracket 150.

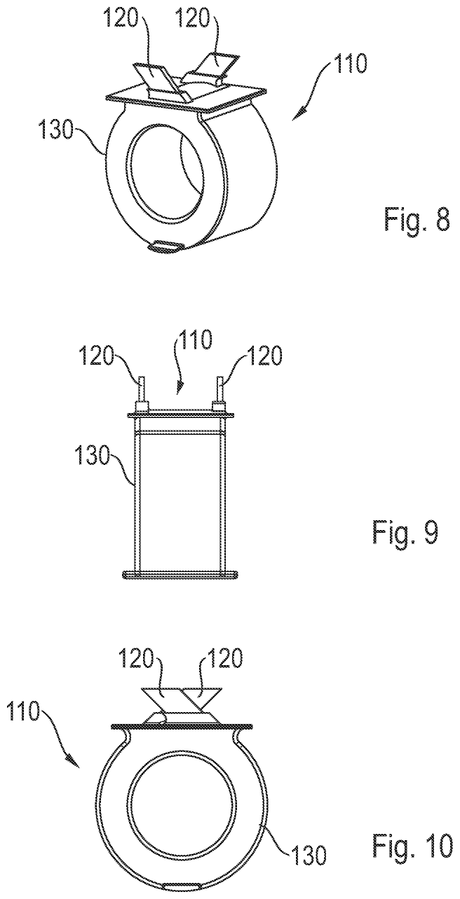

FIGS. 8, 9, and 10 show the second variation of a winding 110 encased in a housing 130 described herein from various perspectives. The outer winding core 125 of the inductor 100 has not yet been placed thereon.

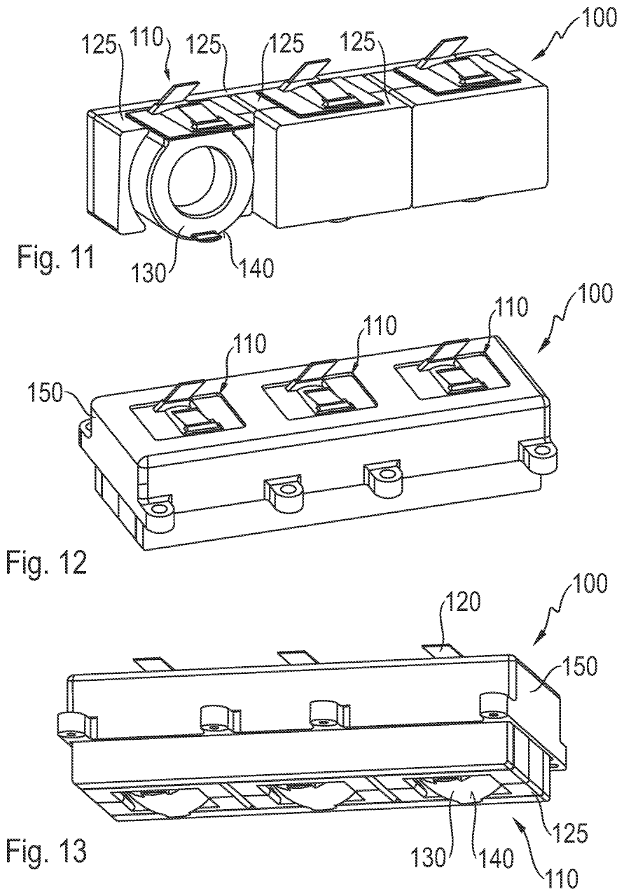

FIGS. 11, 12, and 13 show the second variation of an inductor 100 described herein, with numerous windings 110 in individual housings 130 and an external winding core 125, from various perspectives.

The winding core 125 in FIG. 11 has multiple parts. Each winding 110 has two dedicated elements. Two other elements of the winding core 125 extend over all three of the windings 110 shown herein. For purposes of clarity with regard to explaining the structure, one of the dedicated elements, and one of the shared elements of the winding core 125 have been omitted.

The assembly shown in FIG. 11 is shown with all of the elements of the winding core 125 and the bracket 150 in FIG. 12.

FIG. 13 shows the inductive element shown in FIG. 12 from another perspective.

### REFERENCE SYMBOLS

100 inductor
105 conductor
110 winding
115 support element
120 terminal
125 winding core
130 housing
135 fastener
140 cooling surface
145 thermally conductive element
150 bracket
155 plate
500 method
505 providing the winding core
510 placing the winding on the winding core
515 encasing the winding core and winding
520 providing the housing with a thermally conductive element
525 mounting the housing on the cooling element
530 providing the winding
535 coating the winding
540 placing the winding core thereon
605 cooling element

1. An inductor, comprising:
a winding with a predefined inductance;
a soft magnetic winding core; and
a housing with a cooling surface configured to discharge heat from the inductor,
wherein the housing is applied to the winding with an injection molding process.

2. The inductor according to claim 1, wherein the housing comprises a thermally conductive thermosetting polymer.

3. The inductor according to claim 1, wherein the winding core is ring-shaped.

4. The inductor according to claim 1, wherein the winding core is inside the housing.

5. The inductor according to claim 1, wherein the winding core is outside the housing.

6. The inductor according to claim 5, wherein the winding core acts on numerous windings in individual housings.

7. The inductor according to claim 1, wherein the winding core is made of two parts that are placed on the windings.

8. The inductor according to claim 1, wherein the inductor comprises a choke.

9. The inductor according to claim 1, wherein the inductor is configured for use in an electric drive train.

10. A method for producing an inductor, the method comprising:
providing a soft magnetic winding core;
placing a winding on the winding core; and
coating the winding core and winding to form a housing.

11. A method for producing an inductor, the method comprising:
providing a winding;
coating the winding to form a housing; and
placing a soft magnetic winding core on the housing.
